(19) United States
(12) Patent Application Publication
(10) Pub. No.: US 2008/0189928 A1
(43) Pub. Date: Aug. 14, 2008

(54) Stent Ring Surface Formation

(75) Inventor: Mark Dolan, Santa Rosa, CA (US)

Correspondence Address: MEDTRONIC VASCULAR, INC.;IP LEGAL DEPARTMENT, 3576 UNOCAL PLACE, SANTA ROSA, CA, 95403, US

(73) Assignee: Medtronic Vascular, Inc., Santa Rosa, CA (US)

(21) Appl. No.: 11/673,684

(22) Filed: Feb. 12, 2007

(51) Int. Cl. B23P 23/00; B23P 13/00

(52) U.S. Cl. 29/458; 29/557; 29/700

(57) ABSTRACT

A method of manufacturing a drug-carrying stent includes cutting a plurality of stent rings from a blank, stamping a plurality of dimples in at least one side of the stent rings, bending the stamped stent rings into a stent segment, and attaching the stent segments together.

### TECHNICAL FIELD

This invention relates generally to biomedical devices that are used for treating vascular conditions. More specifically, the invention relates to a stent assembly that includes a modified surface.

### BACKGROUND OF THE INVENTION

Stents are generally cylindrical shaped devices that are radially expandable to hold open a segment of a blood vessel or other anatomical lumen after implantation into the body lumen. Stents have been developed with coatings to deliver drugs or other therapeutic agents.

Various types of stents are in use, including balloon expandable and self-expanding stents. Balloon expandable stents generally are conveyed to the area to be treated on balloon catheters or other expandable devices. For insertion, the stent is positioned in a compressed configuration along the delivery device, for example crimped onto a balloon that is folded or otherwise wrapped about a guide catheter that is part of the delivery device. After the stent is positioned across the lesion, it is expanded by the delivery device, causing the stent diameter to expand. For a self-expanding stent, commonly a sheath is retracted, allowing expansion of the stent.

Stents are used in conjunction with balloon catheters in a variety of medical therapeutic applications including intravascular angioplasty. For example, a balloon catheter device is inflated during PTCA (percutaneous transluminal coronary angioplasty) to dilate a stenotic blood vessel. The stenosis may be the result of a lesion such as a plaque or thrombus. After inflation, the pressurized balloon exerts a compressive force on the lesion thereby increasing the inner diameter of the affected vessel. The increased interior vessel diameter facilitates improved blood flow. Soon after the procedure, however, a significant proportion of treated vessels re-narrow or collapse.

To prevent acute vessel narrowing or collapse, short flexible cylinders, or stents, constructed of metal or various polymers are implanted within the vessel to maintain lumen size. The stents acts as a scaffold to support the lumen in an open position. Various configurations of stents include a cylindrical tube defined by a mesh, interconnected stents or like segments. Balloon-expandable stents are mounted on a collapsed balloon at a diameter smaller than when the stents are deployed. Stents can also be self-expanding, growing to a final diameter when deployed without mechanical assistance from a balloon or like device.

Stent insertion may cause undesirable reactions such as inflammation, infection, thrombosis, and proliferation of cell growth that occludes the passageway. Stents have been used with coatings to deliver drugs or other therapeutic agents at the site of the stent that may assist in preventing these conditions. In some methods of producing a stent designed to deliver a drug, the drug coating is applied to a stent framework. This may result in the drug being delivered to only those portions of the vessel in direct contact with the stent. The coating can be applied as a liquid containing the drug or other therapeutic agent dispersed in a polymer/solvent matrix. The liquid coating then dries to a solid coating upon the stent. The liquid coating can be applied by dipping or spraying the stent while spinning or shaking the stent to achieve a uniform coating. Combinations of the various application techniques can also be used.

To increase the amount of therapeutic agent that may be deposited on the surface of the stent, the surface of the stent framework can be modified. Modifications may take the form of channels, holes or grooves on the stent surface as well as holes extending through the stent framework. However, placement of these modifications in a consistent manner is difficult leading to inconsistent amounts of drug deposition and elution.

Some previous methods for forming surface modifications have included mechanical alterations to a formed stent. However, such mechanical processing can result in undesirable mechanical stress and/or strain on the materials. This increased stress/strain can reduce mechanical integrity.

It would be desirable, therefore, to provide a stent having a modified surface for improved drug delivery that would overcome these and other disadvantages.

### SUMMARY OF THE INVENTION

One aspect of the present invention provides a method of manufacturing a drug-carrying stent that includes cutting a plurality of stent rings from a blank, stamping a plurality of dimples in at least one side of the stent rings, bending the stamped stent rings into a stent segment, and attaching the stent segments together.

Another aspect of the present invention provides a method of manufacturing a drug-carrying stent that includes cutting a plurality of stent rings from a blank, and simultaneously stamping a plurality of dimples in at least one side of the stent rings. The method further includes bending the stamped stent rings into a stent segment, and attaching the stent segments together.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 shows a stent delivery system made in accordance with the present invention;

FIG. 2 shows a stent made in accordance with the present invention;

FIG. 3 is a flow chart illustrating a method of manufacturing a drug carrying stent in accordance with the present invention

FIG. 4 is a flow chart illustrating a method of manufacturing a drug carrying stent in accordance with the present invention

FIG. 5 is a flow chart illustrating a method of manufacturing a drug carrying stent in accordance with the present invention

FIG. 6 is a flow chart illustrating a method of manufacturing a drug carrying stent in accordance with the present invention;

FIG. 7 illustrates an exemplary blank stent strut;

FIG. 8 illustrates an exemplary stamped stent strut, in accordance with one aspect of the invention;

FIG. 9 is illustrates an exemplary bent stamped stent strut, in accordance with the present invention;

FIG. 10 illustrates two attached bent stamped stent rings, in accordance with another aspect of the invention;

FIG. 11 illustrates dimples disposed on a sidewall surface of the stent framework, in accordance with another aspect of the invention; and

FIG. 12 illustrates an exemplary blank prior to stamping a stent strut, in accordance with another aspect of the invention.

### DETAILED DESCRIPTION OF THE PRESENTLY PREFERRED EMBODIMENT

The invention will now be described by reference to the drawings wherein like numbers refer to like structures.

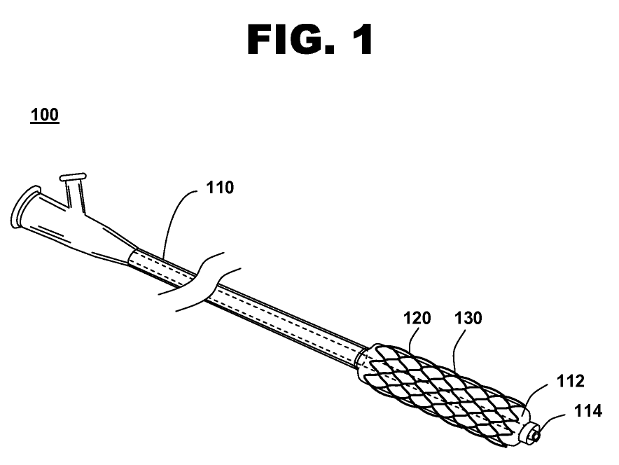

FIG. 1 shows an illustration of a system 100 for treating a vascular condition. The system includes a stent 120 coupled to a delivery catheter 110. Stent 120 includes a stent framework 130. In one embodiment, at least one drug coating, or a drug-polymer layer, is applied to a surface of the stent framework.

Insertion of stent 120 into a vessel in the body helps treat, for example, heart disease, various cardiovascular ailments, and other vascular conditions. Catheter-deployed stent 120 typically is used to treat one or more blockages, occlusions, stenoses, or diseased regions in the coronary artery, femoral artery, peripheral arteries, and other arteries in the body. Treatment of vascular conditions may include the prevention or correction of various ailments and deficiencies associated with the cardiovascular system, the cerebrovascular system, urinogenital systems, biliary conduits, abdominal passageways and other biological vessels within the body.

The stent 120 can be made of a wide variety of medical implantable materials, such as stainless steel, tantalum, nitinol, ceramic, nickel, titanium, aluminum and their alloys, polymeric materials, MP35 alloys, MP35N, MP35W, titanium ASTM F63-83 Grade 1, niobium, high carat gold K 19-22, or combinations and alloys of the above. The stent 120 can be formed through various methods as well. The stent frame 120 can be welded, laser cut, or molded, among other techniques. Depending on the material, stent 120 can be self-expanding or be expanded by a balloon or some other device. Self-expanding stents can be made of materials such as shape memory metal or temperature memory metal, for example.

Catheter 110 of an exemplary embodiment of the present invention includes a balloon 112 that expands and deploys the stent within a vessel of the body. After positioning stent 120 within the vessel with the assistance of a guide wire traversing through a guide wire lumen 114 inside catheter 110, balloon 112 is inflated by pressurizing a fluid such as a contrast fluid or saline solution that fills a tube inside catheter 110 and balloon 112. Stent 120 is expanded until a desired diameter is reached, and then the contrast fluid is depressurized or pumped out, separating balloon 112 from stent 120 and leaving the stent 120 deployed in the vessel of the body. Alternately, catheter 110 may include a sheath that retracts to allow expansion of a self-expanding version of stent 120.

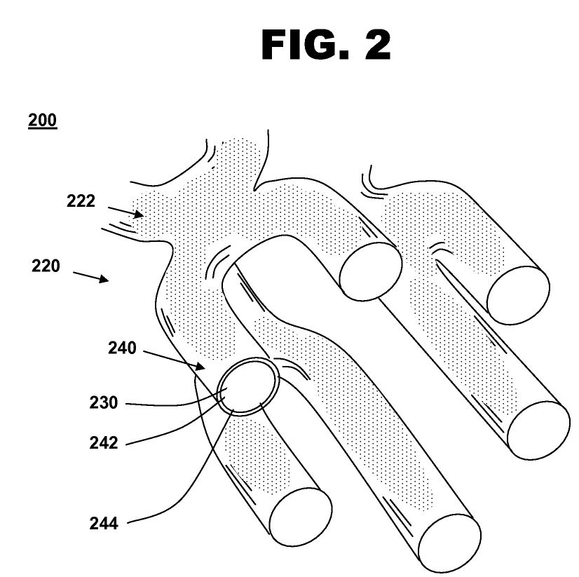

FIG. 2 shows a cross-sectional perspective view of a stent, in accordance with one embodiment of the present invention at 200. Stent 220 includes a stent framework 230.

Stent framework 230 comprises a metallic base formed of appropriate materials, such as magnesium, cobalt-chromium, stainless steel, nitinol, tantalum, MP35N alloy, platinum, titanium, a chromium-based alloy, a suitable biocompatible alloy, a suitable biocompatible material, a biocompatible polymer, or a combination thereof.

In one embodiment, a drug coating 240 is disposed on stent framework 230. In certain embodiments, drug coating 240 includes at least one drug layer 242. In other embodiments, at least one coating layer 244 is disposed over the stent framework, and can envelop or surround the drug coating layer. For example, drug layer 242 includes at least a first therapeutic agent. In one embodiment, the coating layer is a topcoat.

Although illustrated with one set of drug layers and coating layers, multiple sets of drug and coating layers may be disposed on stent framework 230. For example, ten sets of layers, each layer on the order of 0.1 micrometers thick, can be alternately disposed on stent framework 230 to produce a two-micrometer thick coating. In another example, twenty sets of layers, each layer on the order of 0.5 micrometers thick, can be alternately disposed on stent framework 230 to produce a twenty-micrometer thick coating. The drug layers and the coating layers need not be the same thickness, and the thickness of each may be varied throughout drug coating 240. In one example, at least one drug layer 242 is applied to an outer surface of the stent framework. The drug layer can comprise a first therapeutic agent such as camptothecin, rapamycin, a rapamycin derivative, or a rapamycin analog. In another example, at least one coating layer 244 comprises a magnesium layer of a predetermined thickness.

FIG. 2 illustrates the stent framework as substantially tubular in cross-section. However, alternate geometric arrangements are contemplated. For example, a substantially planar construction is used in certain embodiments.

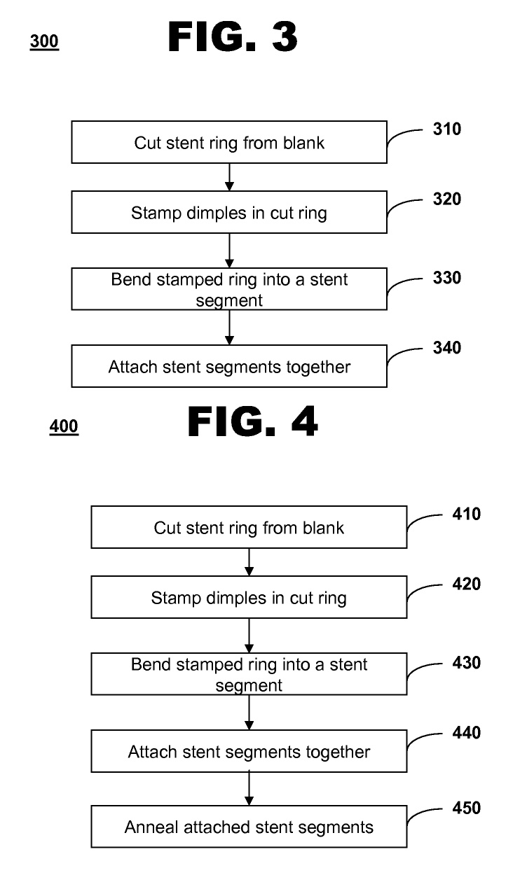

FIG. 3 illustrates one embodiment of a method 300 for manufacturing a drug carrying stent, in accordance with one aspect of the invention. A plurality of stent rings is cut from a blank at step 310. Each stent ring is manufactured by cutting a ‘washer’ from a blank. The blank is any sheet of material, such as a sheet of sheet metal to be formed into the stent strut. Any appropriate cutting device may be used, such as edges, laser or plasma cutting. A plurality of dimples is stamped into at least one side of the cut stent rings at step 320. The dimples are mechanically stamped by adding protrusions to a forming tool. In one embodiment, the forming tool is the same tool as the cutting tool, such that a plurality of dimple-forming protrusions are disposed near the cutting implement. A compression load is applied to the stent ring via the tool through the protrusions to the material. This compression load dimples the surface of the stent ring. The stamping creates a dimple with a first geometric configuration based on the shape of the protrusion. In one embodiment, the first geometric configuration is substantially circular.

The stamped stent rings are bent into a stent segment at step 330. The assembly shape can be any desired geometric configuration. In one embodiment, the assembly shape is substantially sinusoidal. Bending the stamped stent rings distorts the first geometric configuration. For example, in embodiments where the first geometric configuration is substantially circular, bending the stamped struts results in the dimples assuming a more oblong or ovoid configuration. Where the first geometric configuration is more substantially ovoid, the distortion resulting from bending the strut will exaggerate the curvature of at least one of the curves.

The stent segments are attached together at step 340. The stent segments can be attached using any appropriate technology, such as welding. In one embodiment, the stent segments are attached at a crown portion at the bend of the strut.

FIG. 4 illustrates one embodiment of a method 400 for manufacturing a drug carrying stent in accordance with one aspect of the invention. Steps 410, 420, 430, and 440 are implemented as steps 310, 320, 330 and 340 respectively of method 300.

At step 450, the attached bent struts are annealed. Annealing results in releasing many of the material strains resulting from the cutting and stamping processes in working the material to assume the desired assembly shape. With the methods disclosed herein, the annealing takes place only after the formation of the dimples in the stent strut surface.

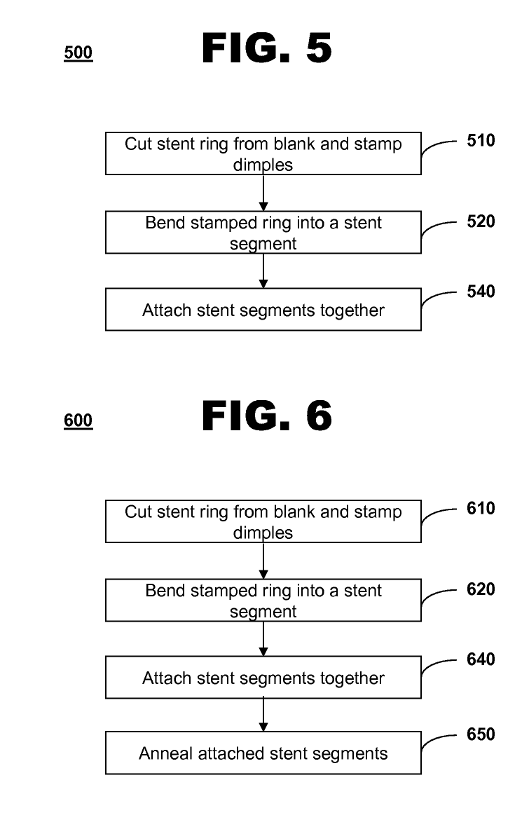

FIG. 5 illustrates one embodiment of a method 500 for manufacturing a drug carrying stent, in accordance with one aspect of the invention. A plurality of stent rings is cut from a blank and a plurality of dimples are stamped in at least one side of the stent rings substantially simultaneously with the cutting at step 510. Each stent ring is manufactured by cutting a ‘washer’ from a blank. The blank is any sheet of material, such as a sheet of sheet metal to be formed into the stent strut. Any appropriate cutting device may be used, such as edges, laser or plasma cutting. The dimples are mechanically stamped by adding protrusions to the cutting tool, such that a plurality of dimple-forming protrusions are disposed near the cutting implement. A compression load is applied to the stent ring via the tool through the protrusions to the material. This compression load dimples the surface of the stent ring. The stamping creates a dimple with a first geometric configuration based on the shape of the protrusion. In one embodiment, the first geometric configuration is substantially circular.

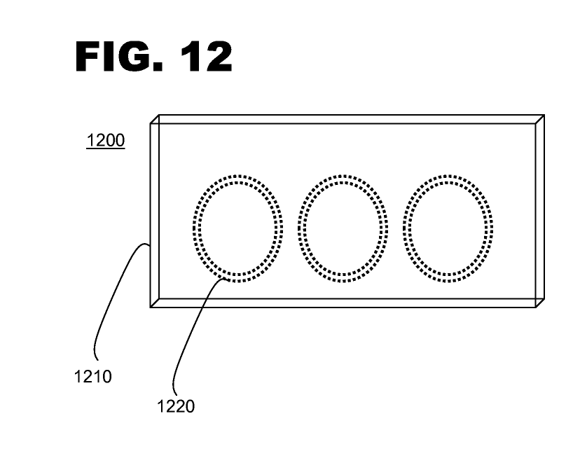

An example of a blank is illustrated in FIG. 12. Blank 1200 includes a substantially flat strip of material 1210 with strut 1220. Strut 1220 is illustrated with dotted lines, indicating that the strut has not been cut from the material yet.

The stamped stent rings are bent into a stent segment at step 520. The stent segment can be any desired geometric configuration. In one embodiment, the stent segment is substantially sinusoidal. Bending the stamped stent rings distorts the first geometric configuration. For example, in embodiments where the first geometric configuration is substantially circular, bending the stamped struts results in the dimples assuming a more oblong or ovoid configuration. Where the first geometric configuration is more substantially ovoid, the distortion resulting from bending the strut will exaggerate the curvature of at least one of the curves. In embodiments wherein the stamped stent rings are formed in a washer type shape, the bending of the struts will result in the dimples being disposed on the sidewall surface of the strut, rather than on the inner diameter of the framework, or on the outer diameter of the framework. In such embodiments, the bending force is applied substantially parallel to the axis defined by the lumen formed by the lumen of the washer. FIG. 11 illustrates the dimples 820 disposed on a sidewall 1150 of the framework. FIG. 11 illustrates only one segment of the framework. In addition, FIG. 11 illustrates the dimples 820 only on the connecting portions of the framework, and no dimples at the crowns of the framework, although this is not a limitation of the disclosures herein.

The stent segments are attached together at step 540. The stent segments can be attached using any appropriate technology, such as welding. In one embodiment, the stent segments are attached at a crown portion at the bend of the strut.

FIG. 6 illustrates one embodiment of a method 600 for manufacturing a drug carrying stent in accordance with one aspect of the invention. Steps 610, 620, and 640 are implemented as steps 510, 520, and 540 respectively of method 500.

At step 650, the attached bent struts are annealed. Annealing results in releasing many of the material strains resulting from the cutting and stamping processes in working the material to assume the desired assembly shape. With the methods disclosed herein, the annealing takes place only after the formation of the dimples in the stent strut surface.

In certain embodiments of the invention, at least one drug is applied to the attached stent segments. The drug is applied after any annealing step is performed to reduce damage to the drug. The drug can be applied directly to a bare metal stent surface, or the drug can be included within a drug polymer. The drug can include one or more bioactive drugs or agents. The bioactive agent is an agent against one or more conditions including coronary restenosis, cardiovascular restenosis, angiographic restenosis, arteriosclerosis, hyperplasia, and other diseases and conditions. For example, the bioactive agent can be selected to inhibit or prevent vascular restenosis, a condition corresponding to a narrowing or constriction of the diameter of the bodily lumen where the stent is placed. In one embodiment, the bioactive drug comprises an antirestenotic agent. In another embodiment, the bioactive drug comprises a bioactive agent such as an antisense agent, an antineoplastic agent, an antiproliferative agent, an antithrombogenic agent, an anticoagulant, an antiplatelet agent, an antibiotic, an anti-inflammatory agent, a steroid, a gene therapy agent, a therapeutic substance, an organic drug, a pharmaceutical compound, a recombinant DNA product, a recombinant RNA product, a collagen, a collagenic derivative, a protein, a protein analog, a saccharide, and a saccharide derivative. In another embodiment, the drug includes a combination or cocktail of pharmaceutical drugs. The polymer is selected from appropriate polymers, including, but not limited to, urethane, polyester, epoxy, polycaprolactone (PCL), polymethylmethacrylate (PMMA), PEVA, PBMA, PHEMA, PEVAc, PVAc, Poly N-Vinyl pyrrolidone, Poly (ethylene-vinyl alcohol), combinations of the above, and the like. In addition to drugs and polymers, a suitable solvents can be used to carry the drug or polymer, including, but not limited to, acetone, ethyl acetate, tetrahydrofuran (THF), chloroform, N-methylpyrrolidone (NMP), combinations of the above, and the like. The drug and/or polymer can be attached to a slip or primer coat in certain embodiments. In other embodiments, a cap coat is added to envelop or surround the drug and/or polymer.

A number of pharmaceutical drugs have the potential to be used in drug-polymer coatings. For example, an antirestenotic agent such as rapamycin prevents or reduces the recurrence of narrowing and blockage of the bodily vessel. An antisense drug works at the genetic level to interrupt the process by which disease-causing proteins are produced. An antineoplastic agent is typically used to prevent, kill, or block the growth and spread of cancer cells in the vicinity of the stent. An antiproliferative agent may prevent or stop targeted cells or cell types from growing. An antithrombogenic agent actively retards blood clot formation. An anticoagulant often delays or prevent blood coagulation with anticoagulant therapy, using compounds such as heparin and coumarins. An antiplatelet agent may be used to act upon blood platelets, inhibiting their function in blood coagulation. An antibiotic is frequently employed to kill or inhibit the growth of microorganisms and to combat disease and infection. An anti-inflammatory agent such as dexamethasone can be used to counteract or reduce inflammation in the vicinity of the stent. At times, a steroid is used to reduce scar tissue in proximity to an implanted stent. A gene therapy agent may be capable of changing the expression of a person's genes to treat, cure or ultimately prevent disease.

By definition, a bioactive agent is any therapeutic substance that provides treatment of disease or disorders. An organic drug is any small-molecule therapeutic material. A pharmaceutical compound is any compound that provides a therapeutic effect. A recombinant DNA product or a recombinant RNA product includes altered DNA or RNA genetic material. Bioactive agents of pharmaceutical value may also include collagen and other proteins, saccharides, and their derivatives. The molecular weight of the bioactive agent typically range from 200 to 60,000 Dalton and above.

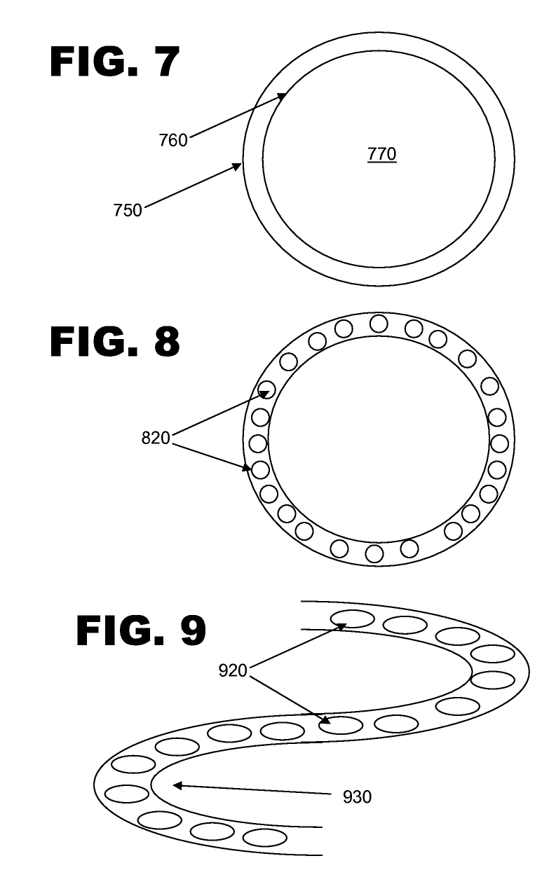

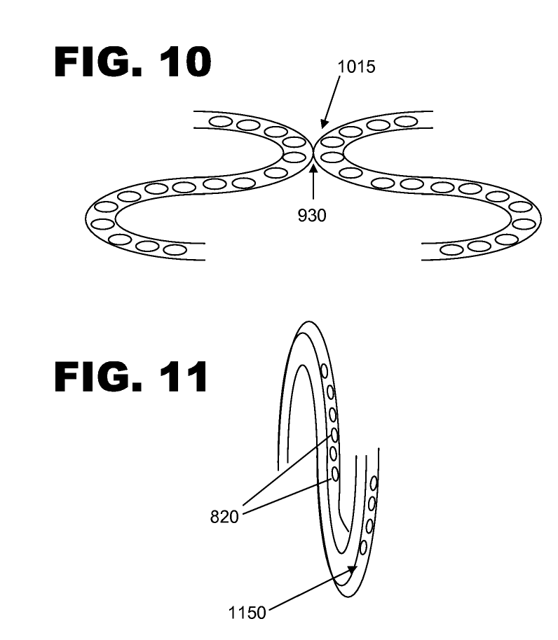

FIG. 7 illustrates a cut blank stent ring prior to bending. The stent ring has a ‘washer’ appearance with an outer diameter 750, and inner diameter 760. The inner diameter defines a lumen 770. FIG. 8 illustrates the cut blank with a plurality of stamped dimples 820 on a surface of the ring. The dimples 820 are in a first geometric configuration, here substantially circular. FIG. 9 illustrates the bent stent ring, including a plurality of dimples 920. Dimples 920 have been distorted by the bending process, here assuming a substantially ovoid configuration. The depiction here is not necessarily to scale, and the degree of deformation is not intended to be evocative of the actual degree of deformation resulting from the distortion. Other geometric distributions of dimples are anticipated, and the illustrated geometric distributions are illustrative only. The distribution of dimples can be selected to increase or reduce the volume of drug carried, and to avoid or focus on particular spans of the stent ring, such as to avoid placing dimples on high strain areas such as the crown. Alternatively, the size of the dimples can be controlled based on volumes of drug to be carried, material strength factors, and characteristics of either the drug or polymer, or both. The bending creates a crown portion 930. FIG. 10 illustrates two stent segments welded 1015 together at crown portion 930.

As shown in FIG. 9, the dimples are disposed on a sidewall of the stent segment, rather than on the inner diameter or outer diameter of the stent segment. The sidewall is the wall disposed substantially perpendicular to the inner diameter and outer diameter of the stent segment. In other embodiments, additional dimples are disposed on the inner and/or outer diameter of the stent segment. In such embodiments, the inner/outer diameter dimples can be formed prior to annealing, or after annealing. In these embodiments, the inner/outer diameter dimples can be formed using mechanical forces, such as stamping, or chemical reactants, such as etching or lithography. Other techniques for forming dimples can also be used to form the inner/outer diameter dimples.

In other embodiments, the cut and stamped stent rings are further processed to refine their shape prior to bending. In one embodiment, the cut and stamped rings are tumbled to round the corners of the cut material prior to bending. In another embodiment, the rings are swaged prior to further processing. In yet other embodiments, the cut stamped rings are filed or ground to obtain desired physical characteristics. In yet other embodiments, chemical treatments, such as etching, lithography, or the like, are applied to gain further desired physical characteristics.

In another embodiment, the stent framework is formed of bioerodable and/or bioabsorbable materials, and a hydroactive solution is maintained within the channels. A topcoat surrounds the framework, and maintains the hydroactive solution within the channels. As the topcoat leaches or elutes off the framework, the hydroactive solution is exposed to the vessel environment, and accerlerates the erosion/absorption of the stent framework.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

I claim:

1. A method of manufacturing a drug-carrying stent, the method comprising:
cutting a plurality of stent rings from a blank;
stamping a plurality of dimples in at least one side of the stent rings;
bending the stamped stent rings into a stent segment; and
attaching the stent segments together.

2. The method of claim 1 wherein the stamping and cutting is performed simultaneously.

3. The method of claim 1 further comprising annealing the attached stent segments.

4. The method of claim 1 further comprising tumbling the stamped stent rings prior to bending the stamped stent rings.

5. The method of claim 1 wherein stamping the dimples comprises forming a dimple with a first geometric configuration and wherein bending the stamped stent rings comprises distorting the first geometric configuration.

6. The method of claim 1 wherein the stent segment is substantially sinusoidal.

7. The method of claim 1 wherein attaching the stent segments comprises welding the stent segments together.

8. The method of claim 7 wherein the stent segments are welded at a crown portion of each stent segment.

9. The method of claim 1 further comprising applying a drug to the attached stent segments.

10. The method of claim 9 wherein the drug is contained within a polymer.

11. The method of claim 9 wherein the drug is applied to a bare metal surface of the attached stent segments.

12. A method of manufacturing a drug-carrying stent, the method comprising:
cutting a plurality of stent rings from a blank;
stamping a plurality of dimples in at least one side of the stent rings simultaneously with the cutting;
bending the stamped stent rings into a stent segment; and
attaching the stent segments together.

13. The method of claim 12 further comprising annealing the attached stent segments.

14. The method of claim 12 further comprising applying a drug to the attached stent segments.

15. The method of claim 14 wherein the drug is contained within a polymer.

16. The method of claim 14 wherein the drug is applied to a bare metal surface of the attached stent segments.

17. A system for manufacturing a drug-carrying stent, the system comprising:
means for cutting a plurality of stent rings from a blank simultaneously with stamping a plurality of dimples in at least one side of the stent rings;
means for bending the stamped stent rings into a stent segment; and
means for attaching the stent segments together.
